(19) United States
(12) Patent Application Publication
(10) Pub. No.: US 2017/0353025 A1
(43) Pub. Date: Dec. 7, 2017

(54) Method and Apparatus for Automatic Electricity Backfeed Protection

(71) Applicant: Electrical Safety Products, LLC, Robert, LA (US)

(72) Inventor: Timothy Franklin Phillips, Folsom, LA (US)

(21) Appl. No.: 15/267,258

(22) Filed: Sep. 16, 2016

Related U.S. Application Data
(60) Provisional application No. 62/343,942, filed on Jun. 1, 2016.

(51) Int. Cl. H02H 3/00; H02J 3/06

(52) U.S. Cl. CPC H02H 3/003; H02J 3/06

(57) ABSTRACT

An electricity backfeed protection assembly is beneficially installed between a main circuit breaker panel of a structure or dwelling, and a utility meter measuring electricity delivered to the structure or dwelling by a utility provider or other primary power source. The electricity backfeed protection assembly includes a contactor having a coil. A contact protector device is electrically connected to the coil of the contactor. The electrical backfeed protection assembly automatically prevents electricity from a secondary power source (including, without limitation, a portable generator) from backfeeding into supply lines of a primary power source (such as utility lines or equipment).

### CROSS REFERENCES TO RELATED APPLICATION

Priority of U.S. Provisional Patent Application Ser. No. 62/343,942, filed Jun. 1, 2016, incorporated herein by reference, is hereby claimed.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

### 1. Field of the Invention

The present invention pertains to a method and apparatus for protecting against unwanted electricity backfeed. More particularly, the present invention pertains to an electricity backfeed protection assembly that can be used in connection with stand alone electricity generators. More particularly still, the present invention pertains to an electricity backfeed protection assembly to prevent stand alone generators from inadvertently sending electrical current into a power grid.

### 2. Brief Description of the Prior Art

Frequently, private residences and businesses receive electrical power from a utility or other third party provider. However, such electrical power supply can sometimes be temporarily interrupted for a variety of reasons including, without limitation, natural disaster or severe weather. In such instances, a homeowner or business owner may desire a “back-up” source of electrical power to provide electricity during periods in which such utility power is unavailable.

Frequently, such back-up power sources can comprise stand alone or stand-by generators that provide electricity during prolonged utility power outages or interruptions. Although designs and configurations can vary, such stand alone generators typically include an engine (such as, for example, an internal combustion engine powered by gasoline, diesel, natural gas or other readily available fuel) that powers an alternator in order to generate electricity. Such stand alone generators can be used to provide electricity to power any number of different tools or appliances including, without limitation, refrigerators, electric cooking devices, oxygen-producing machines or other electrically powered medical equipment, air conditioners and/or space heaters during prolonged periods of utility outages or interruption.

In many cases, such stand alone generators are “portable” devices that can be conveniently stored until a need arises, such as during a lengthy power outage. Power outlets on such portable stand alone generators allow users to plug extension cords or electric-powered devices into the generator. Such portable stand alone generators can be used to provide electricity to power any number of different tools or appliances including, without limitation, refrigerators, electric cooking devices, oxygen-producing machines or other electrically powered medical equipment, air conditioners and/or space heaters during periods of utility downtime or interruption.

Although not recommended, users have been known to sometimes supply electricity from a portable generator into the permanent electrical wiring system of a dwelling or other structure, often through an electrical outlet intended for a clothes dryer or another existing interface. This practice, which eliminates that need for a user to run separate extension cords to the portable generator, can nonetheless be extremely dangerous. Notably, electricity from the portable generator can inadvertently backfeed into utility lines, thereby causing electrical current to pass through said utility lines even while power supply from the utility is interrupted.

Such backfeeding of electricity into utility power lines can present a hazard to utility workers (such as, for example, workers attempting to repair equipment and/or restore utility power to customers) who are not expecting live electrical current to be present in certain lines. Such electrical backfeed can also damage or destroy utility equipment that is not designed to receive such back-fed electricity. Further, such electrical backfeed can also present a hazard to those encountering downed power lines such as, for example, following severe weather; in many cases, people encountering such lines can mistakenly and erroneously assume that such back-fed power lines are not “live” because a utility is not supplying electrical power, resulting in injury or death from accidental electrocution.

In some cases, such stand alone generators can be directly connected to the permanent electrical circuits or wiring system of a house or other structure. In such cases, the permanent wiring system of the house or other structure should be disconnected from the utility input lines in order to prevent current generated by the stand alone generator from being back fed into the utility power lines.

In order to address this situation, automatic transfer switches (“ATS”) have been developed to establish electrical connections between utility line(s), the electrical circuit(s) of a dwelling or structure, and a standalone generator. In a typical situation, a sensor connected to said stand alone generator senses when utility power fails or falls drastically and causes said generator to start. Once the operating speed and voltage from the stand alone generator have been attained, an ATS automatically disconnects the utility from the dwelling/structure circuit, and thereafter, cuts in electrical current from the stand alone generator to provide electricity to said dwelling/structure circuit.

In many cases, such permanent stand alone generators may not be started or allowed to run until and unless an actual need arises due to a prolonged power outage. As a result, maintenance of such permanent stand alone generators can often be overlooked or neglected, and such generators can fail to start or function properly when called upon to perform. When that occurs, a portable generator may be used as an additional back up in order to provide electricity to a dwelling or structure. Under such a scenario, a user may mistakenly assume that an ATS has functioned, thereby disconnecting a utility from the dwelling/structure circuit. However, if the ATS does not function, electricity from the portable generator can inadvertently backfeed into utility lines causing various hazards.

In light of the foregoing, there is a need for an efficient and cost effective electrical backfeed protection device that can prevent electricity from a stand alone generator (including, without limitation, a portable generator) from backfeeding into utility lines. The backfeed protection device should be beneficially easy to install, and should function automatically when utility power to a dwelling or other structure is interrupted.

### SUMMARY OF THE INVENTION

The present invention comprises an electricity backfeed protection assembly for preventing the flow of electricity from a secondary power source (such as, for example, a stand alone generator) into electrical circuitry of a primary power source (such as, for example, utility electrical power lines). In a preferred embodiment, said electricity backfeed protection assembly comprises a contactor having a coil; by way of illustration, but not limitation, said contactor can comprise a 600 volt, 200 amp single phase contactor. A contact protector device feeds said coil of said contactor; by way of illustration, but not limitation, said contact protector device can comprise a 240 volt, 20 amp, single phase, double pole breaker device.

In a preferred embodiment, said electricity backfeed protection assembly is beneficially enclosed within a conventional enclosure. Said enclosure can be divided into a utility compartment and a load compartment, separated by a barrier. Said electricity backfeed protection assembly can be beneficially installed between a main circuit breaker panel and a utility meter.

The electrical backfeed protection assembly of the present invention can prevent electricity from a stand alone generator (including, without limitation, a portable generator) from backfeeding into utility lines. The backfeed protection assembly is beneficially easy to install, and functions automatically when utility power to a dwelling or other structure is interrupted.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side view of a structure connected to an electrical utility and a portable stand alone electrical generator.

FIG. 2 depicts a side view of a structure connected to an electrical utility, a permanently mounted stand alone electrical generator, and a portable stand alone electrical generator.

FIG. 3 depicts a schematic view of an electricity backfeed protection device of the present invention.

FIG. 4 depicts a schematic view of a representative conventional residential electricity system including an electricity backfeed protection device of the present invention.

FIG. 5 depicts a schematic view of a alternative conventional residential electricity system including an electricity backfeed protection device of the present invention.

### DETAILED DESCRIPTION OF A PREFERRED EMBODIMENT

FIG. 1 depicts a side view of a structure 10 connected to certain components of an electrical power utility, including utility pole 20, transformer 21 and transmission line 23 extending form said transformer 21 to utility meter 22 disposed on structure 20. A ground line 14 is depicted extending from utility meter 22 to ground the electrical system of structure 10 in a manner well known to those having skill in the art. As depicted in FIG. 1, said electrical power utility represents a primary power source for structure 10.

As depicted in FIG. 1, said structure 10 resembles a conventional dwelling. However, it is to be understood that the present invention can be beneficially utilized in connection with commercial and/or other structures such as, for example, commercial buildings, industrial buildings, schools, hospitals or other structures, without departing from the scope of the present invention.

Still referring to FIG. 1, conventional circuit breaker panel 50 is electrically connected to a conventional permanent wiring system of structure 10 in a manner that is well known to those having skill in the art. Utility meter 22 is electrically connected to electrical backfeed protection assembly 100 of the present invention using electrical wiring 24; said electrical backfeed protection assembly 100 is, in turn, electrically connected to conventional circuit breaker panel 50 using electrical wiring 25. In a preferred embodiment depicted in FIG. 1, said electrical backfeed protection assembly 100 of the present invention is beneficially electrically installed between utility meter 22 and conventional circuit breaker panel 50.

FIG. 1 further depicts stand alone electrical generator 30. Although designs and configurations can vary, stand alone generator 30 represents a secondary power source, and generally comprises an engine (such as, for example, an internal combustion engine powered by gasoline, diesel, natural gas or other readily available fuel) that powers an alternator in order to generate electricity. Stand alone generator 30 can be used to provide electricity to power a number of different tools or appliances in or around said structure 10 including, without limitation, refrigerators, electric cooking devices, oxygen-producing machines or other electrically powered medical equipment, air conditioners and/or space heaters, especially during prolonged periods of utility outages or interruption.

As depicted in FIG. 1, stand alone generator 30 generally comprises a “portable” device that can be conveniently stored (such as indoors or in another protected environment) until a need arises, such as during a lengthy power outage or interruption in electricity being supplied to structure 10 via utility transmission line 23. Said stand alone generator 30 is electrically connected to the permanent electrical wiring circuitry system of structure 10 using electric cord 31 which is plugged in or otherwise connected to electrical outlet 15, which can be a clothes dryer outlet or other similar connection point. As depicted in FIG. 1, said outlet 15 is hard-wired to circuit breaker panel 50 using electrical wiring 51. As noted above, said conventional circuit breaker panel 50 is, in turn, hard wired into the permanent electrical wiring system of structure 10.

In the configuration depicted in FIG. 1, electricity generated by said portable generator 30 can be backfed into the permanent electrical wiring system of structure 10; as depicted in FIG. 1, said portable generator 30 is connected to said permanent electrical wiring system of structure 10 via connection to electrical outlet 15. By way of illustration, electrical outlet 15 can comprise a conventional 220 volt outlet intended for use with a clothes dryer or other similar appliance. Although not recommended for safety reasons, the practice of backfeeding electricity into structure 10 using portable generator 30 is commonly done.

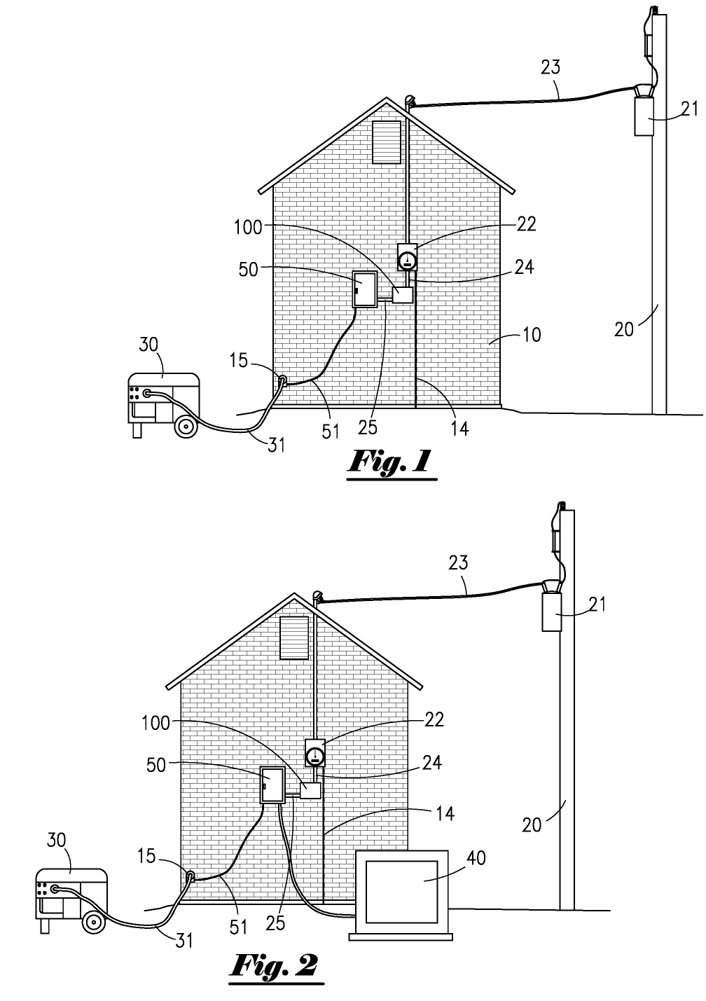

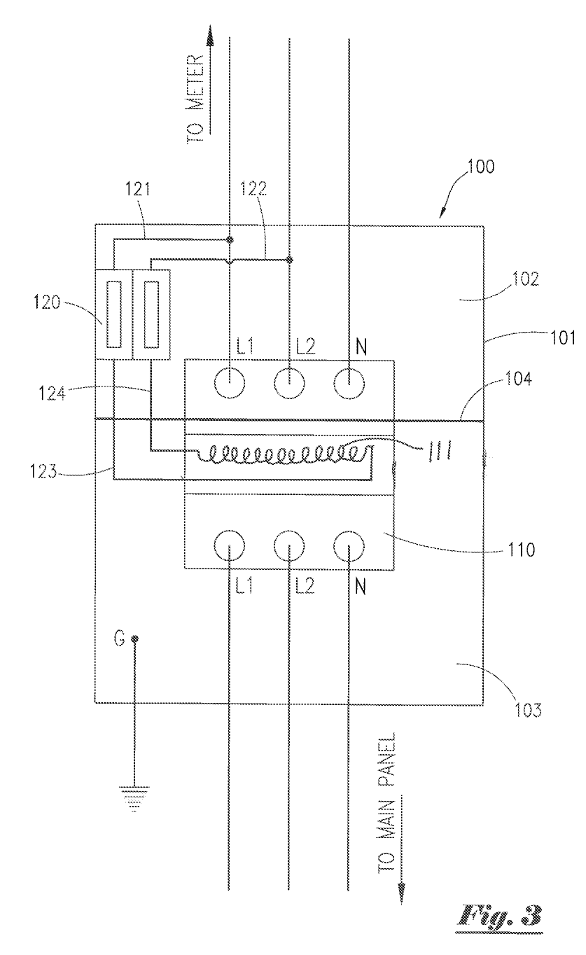

FIG. 2 depicts a side view of a structure 10 connected to an electrical utility via transmission line 23, a permanently mounted stand alone electrical generator 40, and a portable stand alone portable electrical generator 30. As depicted in FIG. 2, transformer 21 is mounted to utility pole 20, while transmission line 23 extends form said transformer 21 to utility meter 22 disposed on structure 20. Ground line 14 is depicted extending from utility meter 22.

Still referring to FIG. 2, conventional circuit breaker panel 50 is electrically connected to the conventional permanent wiring system of structure 10. Utility meter 22 is electrically connected to electrical backfeed protection assembly 100 of the present invention using electrical wiring 24; said electrical backfeed protection assembly 100 is, in turn, electrically connected to conventional circuit breaker panel 50 using electrical wiring 24. As depicted in FIG. 2, said electrical backfeed protection assembly 100 of the present invention is beneficially electrically installed between utility meter 22 and conventional circuit breaker panel 50.

Stand alone generator 40 can be directly connected to the permanent electrical circuits or wiring system of a house or other structure. As depicted in FIG. 2, said stand alone generator 40 is permanently installed, and is electrically connected to the permanent wiring system of structure 10 via electrical wire 41 that electrically connects said stand alone generator 40 to circuit breaker panel 50 (and, in turn, the permanent electrical circuitry of structure 10). Stand alone generator 40 is permanently installed, and comprises a “stand by” electrical generator to supply electrical power to structure 10 during prolonged power interruptions or outages.

Although not visible in FIG. 2, a conventional sensor can be connected to stand alone generator 40 and senses when utility electricity supplied by transmission line 23 ceases or falls significantly. When this occurs, said sensor causes generator 40 to automatically start. Once a predetermined operating speed and voltage from stand alone generator 40 are attained, an ATS automatically electrically disconnects utility transmission line 23 from the permanent electrical wiring system of structure 10. Thereafter, electrical current from stand alone generator 40 is automatically cut in to said permanent wiring system of structure 10 to provide electricity to said structure 10.

In many cases, such permanent stand alone generators such as generator 40 are not started or allowed to run until and unless an actual need arises due to a prolonged power outage. As a result, maintenance of such permanent stand alone generators can often be overlooked or neglected, particularly if long or extended periods elapse between such power outages. In such an instance, generator 40 can fail to start or function properly when called upon to perform; when that occurs, a portable generator 30 may be used as an additional back up in order to provide electricity to structure 10.

Like the configuration depicted in FIG. 1, stand alone generator 30 is depicted in FIG. 2 as electrically connected to the permanent wiring system of structure 10 using electric cord 31 which is plugged in or otherwise electrically connected to electrical outlet 15. Said outlet 15 is, in turn, hard-wired to circuit breaker panel 50 using electrical wiring 51, while conventional circuit breaker panel 50 is hard-wired into a permanent electrical wiring system of structure 10.

Although commonly done, such backfeeding of electricity into the permanent wiring circuitry of structure 10 using portable electrical generator 30 can be hazardous and cause significant danger to personnel and property. Notably, unless properly disconnected, such backfeeding of electricity into the wiring of structure 10 can frequently result in backfeeding of electricity into utility power transmission line 23 and, in some cases, into other parts of a utility grid system.

Such backfeeding of electricity into utility lines and equipment can present a significant safety hazard to utility workers (such as, for example, workers attempting to repair equipment and/or restore utility power to customers) who are not expecting live electrical current to be present in such utility lines. Further, such electrical backfeed can also damage or destroy utility equipment that is not designed to receive such back-fed electricity. Frequently, such electrical backfeed can also present a hazard to those encountering downed power lines such as, for example, residents cleaning up following a severe weather event.

FIG. 3 depicts a schematic view of an electricity backfeed protection assembly 100 of the present invention. Electricity backfeed protection assembly 100 beneficially prevents the backfeed or flow of electricity (such as from a stand alone generator) into utility electrical power lines as more fully described herein. In a preferred embodiment, said electricity backfeed protection assembly 100 comprises a contactor 110 having a coil; by way of illustration, but not limitation, said contactor 110 can comprise a 600 volt, 200 amp single phase contactor. For example, said contactor can comprise a contactor manufactured and marketed by Eaton Corporation under the name “Compact Definite Purpose Contactor”.

A contact protector device 120 feeds (that is, permits current to flow to) said coil of said contactor; by way of illustration, but not limitation, said contact protector device 120 can comprise a 240 volt, 20 amp, single phase, double pole circuit breaker device. For example, said contactor protector device can comprise a circuit breaker manufactured and marketed by Eaton Corporation under the name “BR220”.

In a preferred embodiment, said electricity backfeed protection assembly 100 is beneficially contained within an enclosure 101. Said enclosure 101 can be divided into a utility compartment 102 and a load compartment 103, separated by a barrier 104. As depicted in FIGS. 1 and 2, said electricity backfeed protection assembly 100 can be beneficially installed between a main circuit breaker panel 50 and a utility meter 22.

The electrical backfeed protection assembly of the present invention can prevent electricity from a stand alone generator (including, without limitation, a portable generator 30) from backfeeding into utility lines, such as utility transmission line 23. The backfeed protection assembly is beneficially easy to install, and functions automatically when utility power to a dwelling or other structure is interrupted.

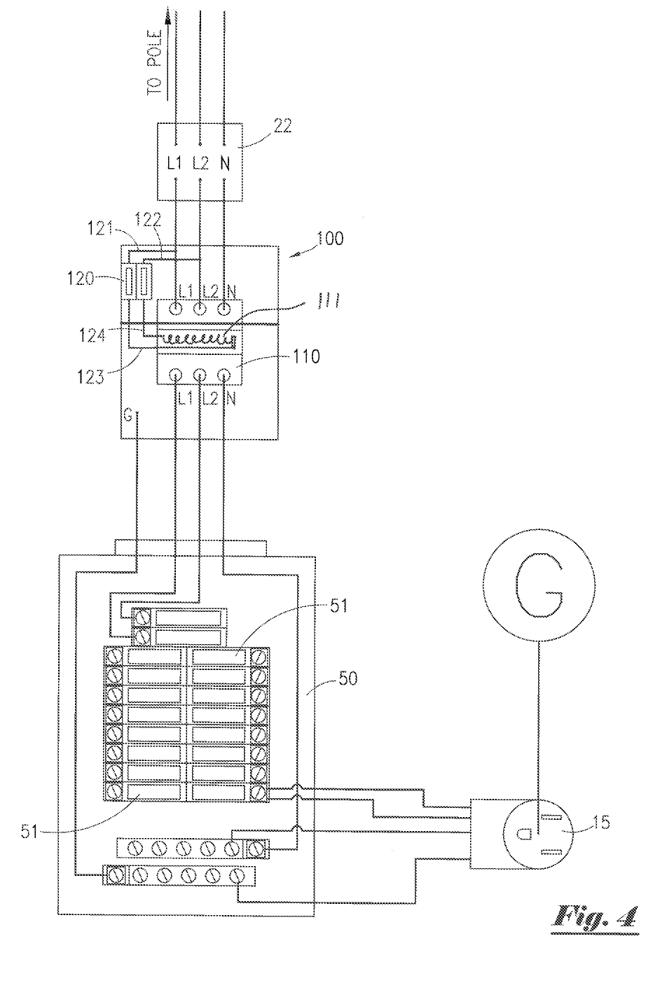

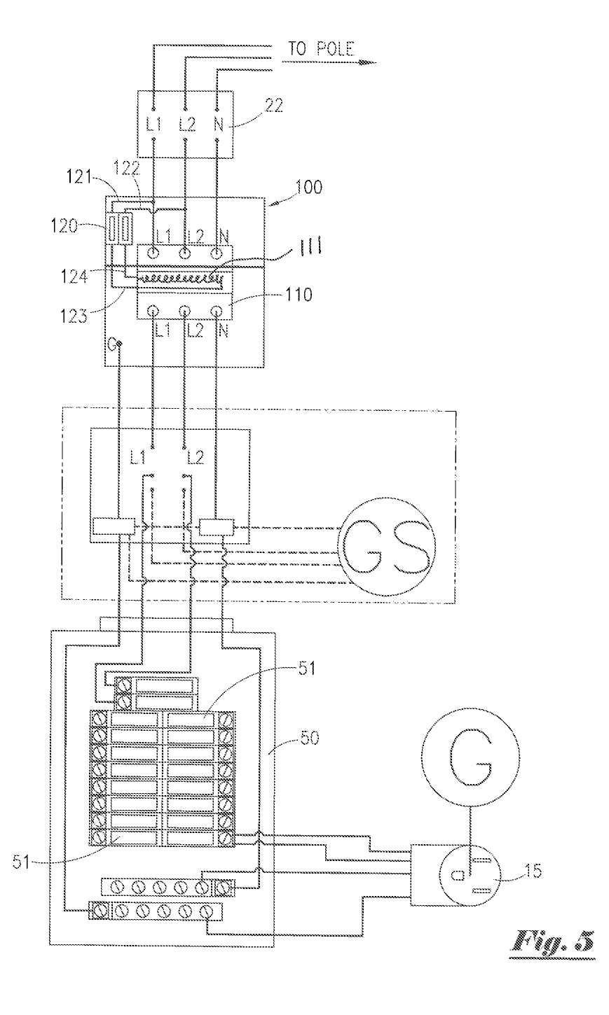

FIG. 4 depicts a schematic view of a representative conventional residential electricity system including an electricity backfeed protection assembly 100 of the present invention, while FIG. 5 depicts a schematic view of an alternative conventional residential electricity system including an electricity backfeed protection assembly 100 of the present invention.

In operation, electricity backfeed protection assembly 100 can be beneficially electrically installed between an electrical utility supply (such as downstream from an electrical utility meter 22 depicted in FIG. 2) and a conventional circuit breaker assembly (breaker panel 50 depicted in FIG. 2). Referring to FIG. 3, “L1”, “L2” and “N” lines extend from and electrically connect electricity backfeed protection assembly 100 to a utility meter. Similarly, “L1”, “L2” and “N” lines extend from and electrically connect electricity backfeed protection assembly 100 to a main circuit breaker panel of a dwelling or other structure.

Line 121 electrically connects contactor protector 120 to line “L1” between said utility supply and contactor 110, while line 123 electrically connects said contactor protector 120 to coil 111 of contactor 110. Line 122 electrically connects contact protector to line “L2” between said utility supply and contactor 110, while line 124 electrically connects said contactor protector 120 to coil 111 of contactor 110. Lines “L1”, “L2” and “N” extend from and electrically connect contactor 110 to a main circuit breaker panel and provide power supplied by a utility to the permanent electrical wiring circuitry of a dwelling or other structure.

Electricity supplied by a utility via lines “L1” and “L2” pass through contactor protector 120, and energize coil 111 of contactor 110. In this configuration, contactor 110 is in a closed position, permitting electrical current to pass through said contactor 110; more specifically, when contactor 110 is in said closed position, electrical current can flow from a primary power source such as a utility supply through said contactor 110 to a main circuit breaker panel of a dwelling or other structure.

However, when the supply of electricity from a utility via either line “L1” or “L2” (or both of said lines) is interrupted for any reason, contactor protector 120 will function, interrupting an electrical circuit and cutting off the supply of electrical current to coil 111 of contactor 110. When this occurs, contactor 110 will open, essentially breaking the circuits of lines “L1”, “L2” and “N”.

When said contactor 110 is in said open position, electricity supplied by a secondary power source (such as, for example, portable generator 30 or generator 40 depicted in FIG. 2) cannot flow past said open contactor 110. As such, said electricity from said secondary power source can be used to supply power to the permanent electrical wiring system of a dwelling or other structure; however, said electricity cannot be backfed into utility lines supplying said dwelling or other structure from a primary power source.

The electricity backfeed protection assembly 100 of the present invention is “fail safe”, in that it does not require specific activation or functioning by an operator; electricity backfeed protection assembly 100 of the present invention automatically senses when electrical current from a utility or other primary power source is interrupted or lost, and automatically functions to isolate the permanent electrical wiring system of a dwelling or other structure from incoming electrical supply lines so that electricity from a secondary power source will not backfeed into said supply lines of said primary power source.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. A backfeed protection apparatus to prevent power from backfeeding into a primary source of power when a secondary source of power is connected to existing wiring that is normally powered by said primary source of power, said backfeed protection apparatus comprising:
a contactor having a coil, wherein said contactor is electrically connected to said primary source of power and said existing wiring, but not said secondary source of power, and wherein said contactor is adapted to alternate between a first closed position and a second open position; and
a circuit breaker electrically connected with said primary source of power and said coil of said contactor, wherein said circuit breaker is adapted to stop the flow of power to said coil of said contactor when power from said primary source of power is interrupted, thereby causing said contactor to shift from said first closed position to said second open position.

2. The backfeed protection apparatus of claim 1, wherein said primary source of power and said secondary source of power are isolated from one another when said contactor is in said second open position, thereby preventing said secondary source of power from backfeeding into said primary source of power.

3. The backfeed protection apparatus of claim 1 wherein said primary source of power is a utility power grid.

4. The backfeed protection apparatus of claim 1 wherein said secondary source of power is a generator.

5. The backfeed protection apparatus of claim 1, wherein said contactor is electrically installed between said primary source of power and a conventional circuit breaker assembly of a structure.

6. A backfeed protection apparatus to prevent electricity from backfeeding into a primary source of electricity when a secondary source of electricity is connected to existing wiring that is normally powered by said primary source of electricity, said apparatus comprising:
a contactor having a coil, wherein said contactor is electrically connected to said primary source of electricity and said existing wiring, but not said secondary source of power, and wherein said contactor is adapted to alternate between a first closed position and a second open position; and
a circuit breaker electrically connected with said primary source of electricity and said coil of said contactor, wherein said circuit breaker is adapted to stop the flow of electricity to said coil of said contactor when electricity from said primary source of electricity is interrupted, thereby causing said contactor to shift from said first closed position to said second open position.

7. The backfeed protection apparatus of claim 6, wherein said primary source of electricity and said secondary source of electricity are isolated from one another when said contactor is in said second open position, thereby preventing said secondary source of electricity from backfeeding electrical current into said primary source of electricity.

8. The backfeed protection apparatus of claim 6 wherein said primary source of electricity is a utility electricity grid.

9. The backfeed protection apparatus of claim 6 wherein said secondary source of electricity is a generator.

10. The backfeed protection apparatus of claim 6, wherein said contactor is electrically installed between said primary source of electricity and a conventional circuit breaker assembly of a structure.

11. A method for preventing power from backfeeding into a primary source of power when a secondary source of power is connected to existing wiring that is normally powered by said primary source of power, comprising:
a) providing a contactor that is electrically connected to said primary source of power and said existing wiring, but not said secondary source of power, wherein said contactor alternates between only first closed position wherein said primary source of power is electrically connected to said wiring, and a second open position wherein said primary source of power is not electrically connected to said wiring;
b) shifting said contactor from said first closed position to said second open position when power from said primary source of power is interrupted;
c) isolating the primary source of power from a secondary source of power, such that power from said secondary source of power cannot backfeed to said primary source of power.

12. The method of claim 1 wherein said primary source of power is a utility power grid.

13. The method of claim 12 wherein said secondary source of power is a generator.
